(19) United States
(12) Patent Application Publication
(10) Pub. No.: US 2004/0192359 A1
(43) Pub. Date: Sep. 30, 2004

(54) Mobile invoked 'call me' back system for wireless subscribers with insufficient account balances

(76) Inventors: Christopher McRaild, Mississauga (CA); Shyam Sheth, Toronto (CA)

Correspondence Address: REDKNEE INC., 2560 MATHESON BLVD. EAST, SUITE 500, MISSISSAUGA, ON, L4W4W9, CA

(21) Appl. No.: 10/401,986

(22) Filed: Mar. 31, 2003

(51) Int. Cl. H04M 11/00; H04Q 7/20

(52) U.S. Cl. 455/466; 455/406

(57) ABSTRACT

Disclosed is a mobile invoked ‘call me’ back system for wireless subscribers with insufficient account balances disclosed herewith enables mobile subscribers who have insufficient and/or no funds in their prepaid account, to continue using their mobile service nonetheless by initiating a free (in the preferred embodiment) ‘call me’ SMS (Short Message Service) to another mobile subscriber (or equally equipped land-line phone with such capabilities) who then, expectantly, returns the call.

### TECHNICAL FIELD

The present invention relates generally to mobile telephony services and related telecommunication network implementations; and in particular to a mobile invoked ‘call me’ back system for wireless subscribers with insufficient account balances.

### SUMMARY OF THE INVENTION

The mobile invoked ‘call me’ back system for wireless subscribers with insufficient account balances disclosed herewith enables mobile subscribers who have insufficient and/or no funds in their prepaid account, to continue using their mobile service nonetheless by initiating a free (in the preferred embodiment) ‘call me’ SMS (Short Message Service) to another mobile subscriber (or equally equipped land-line phone with such capabilities) who then, expectantly, returns the call.

For instance, to initiate such ‘call me’ messages, a prepaid subscriber (in the example at hand), keys an Unstructured Supplementary Services Data (USSD) string into their mobile and/or wireless handset, which naturally includes the destination number, e.g. *141*16668225671#. The message is then forwarded to the computer program product for implementing the disclosed mobile invoked ‘call me’ back system via, at least in this instance, a USSD gateway (according to the service code routing). In alternate framework embodiments, the computer program product for implementing the disclosed mobile invoked ‘call me’ back system may also perform checks for any subscriber restrictions and also queries the subscriber's balance to ensure it is below the specified amount (to prevent abuse(s) and fraud).

Once these steps remain fulfilled, the mobile invoked ‘call me’ back system, send a short message (SM) to the destination number with a customizable “kindly ring me” message. The logic of the mobile invoked ‘call me’ back system then confirms through a USSD that the message was in fact delivered. Both notification and response messages can be customized by the telecommunications carrier and/or network operator in question, to suit specific service delivery requirements.

### BRIEF DESCRIPTION OF THE DRAWINGS

FIG. 1 illustrates a typical, non-limiting embodiment of the system level architecture employed in the disclosure of present.

### DETAILED DESCRIPTION OF THE PREFERRED EMBODIMENTS

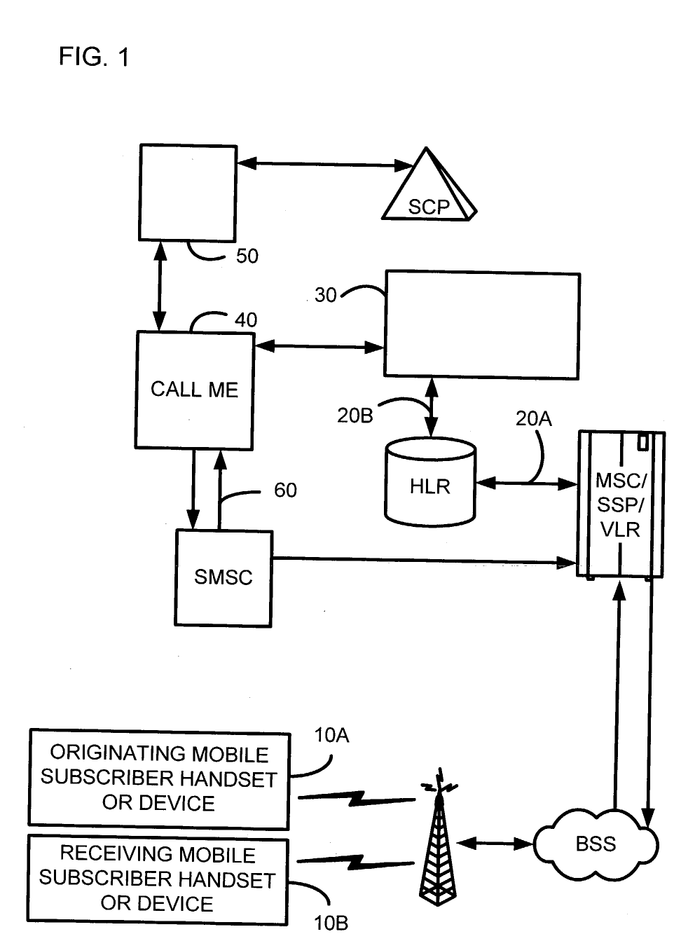

With reference now to FIG. 1, subscriber 10A initiates “call me” notification by entering appropriate Unstructured Supplementary Services Data (USSD) string plus destination number (i.e. *141*16668225671#) or in alternate embodiments, the subscriber 10A may simply enter the USSD shortcode for the mobile invoked ‘call me’ back system (i.e. *141#). Said message is forwarded via 20A and 20B to the computer program product for the mobile invoked ‘call me’ back system via a USSD Gateway 30 (in this instance) (routing based on service code). Indeed, practitioners and other honourable members skilled in the art will recognize that a variety of gateways, portals (et al.) apart from USSD may be utilized without diluting the intent and scope of the invention of present, and its inclusion herewith serves merely for the purpose of elucidation, simplicity and ease of instruction.

Although functionally non-necessary and/or otherwise configurable, it remains preferred that the mobile invoked ‘call me’ back system 40 should check for any subscriber restrictions and queries balance (via an Open Charging (OC) middleware platform and gateway system 50 (as detailed in patent application Ser. No. 10/307335)) to ensure that the subscriber 10A account is in fact actually below the maximum balance threshold. Technicians skilled in the art will recognize that the invention of present need not be limited to the aforementioned Open Charging (OC) middleware platform and gateway system and other similar network implementations may be employed without diluting the intent and scope as such. In alternate embodiments, where the flag CheckDN is enabled, then the mobile invoked ‘call me’ back system checks whether or not the destination MSISDN is in the subscriber table. If it is not, then the application rejects the ‘call me’ invocation. In still further embodiments, logic may be implemented which restricts sending the ‘call me’ message to specific times of the day, certain destination numbers (or ranges thereof), and so on.

Upon successful validation of subscriber restrictions and balance, the mobile invoked ‘call me’ back system 40 sends a short message (SM) to the destination number 10B (via Short Message Peer to Peer Protocol to the appropriate SMSC) with the ‘call me’ message (i.e. “please ring me”). Practitioners skilled in the art will recognize that a variety of signaling systems, protocols and related technologies may be utilized without diluting the intent and scope of the invention of present.

In alternate embodiments, the mobile invoked ‘call me’ back system 40 returns 60 the appropriate message (i.e. “message delivered”) to the subscriber 10A via USSD through the USSD Gateway response mechanism. Indeed as before, practitioners and other honourable members skilled in the art will recognize that a variety of gateways, portals (et al.) apart from USSD may be utilized without diluting the intent and scope of the invention of present, and its inclusion herewith serves merely for the purpose of elucidation, simplicity and ease of instruction.

Preferentially, mobile subscribers will be limited to ‘X’ number of “call me” messages for a given time period (e.g. monthly) to prevent abuse of the service.

What is claimed is:

1. A system and method for a mobile invoked ‘call me’ back system for wireless subscribers with insufficient account balances or other such restrictions placed upon their service/accounts.

2. The system of claim 1, where a wireless subscriber keys a short message (in whatever form) into their mobile handset directing another mobile subscriber (or equally equipped land-line phone with such capabilities) to call them owing to insufficient funds (or other such restrictions) which otherwise inhibit(s) their ability to directly establish a telecommunications connection.

3. The system of claim 2, which applies equally to prepaid and postpaid wireless subscribers depending on the nature of restriction which has been placed on the account.

4. The system of claim 3, where such restrictions can include insufficient account balances, roaming scenarios and so on.

5. The system of claim 2, where the wireless subscriber invokes the ‘call me’ back system via a gateway and portal system (as through USSD for instance).

6. The system of claim 2, whereby the mobile invoked ‘call me’ back system exists as part of a computer program product, comprising:
a) a computer readable memory medium; and
b) a computer program including the logic required to the steps, methods and rules as such.

7. The system of claim 6, wherein mobile invoked ‘call me’ back system checks for any subscriber restrictions and queries balance to ensure that the wireless subscriber account in question is in fact actually below the maximum balance threshold.

8. The system of claim 7, which is accomplished by an Open Charging (OC) middleware platform and gateway system or similar type of method, system and/or apparatus used to perform such checks and/or queries.

9. The system of claim 8, where upon successful validation of any such restrictions (including balance query), the mobile invoked ‘call me’ back system sends a short message (SM) to the destination number (via any numbers of protocols to the SMSC) with the ‘call me’ message (i.e. “please ring me”).

10. The system of claim 8, where the mobile invoked ‘call me’ back system may optionally returns an appropriate message (i.e. “message delivered”) to the originating subscriber via a gateway and portal system (USSD for instance) through the a gateway and portal system response logic and/or similar such mechanism (as with the USSD Gateway response mechanism for instance).

11. A system and method for a mobile invoked ‘call me’ back system for wireless subscribers with insufficient account balances or other such restrictions placed upon their service/accounts, where such system is limited to a certain specified number of ‘call me’ messages for a given time period (e.g. monthly) to prevent abuse of the service.
